(19) United States
(12) Patent Application Publication
(10) Pub. No.: US 2025/0067696 A1
(43) Pub. Date: Feb. 27, 2025

(54) CATION SENSOR MEMBER BASED ON COMPOSITE MATERIAL OF CARBON NANOTUBES AND POLYMERS HAVING FUNCTIONALIZED RECEPTORS, CATION SENSOR, AND MANUFACTURING METHOD THEREFOR

(71) Applicant: IUCF-HYU (INDUSTRY-UNIVERSITY COOPERATION FOUNDATION HANYANG UNIVERSITY), Seoul (KR)

(72) Inventors: Seon-Jin CHOI, Seoul (KR); Seungho CHOI, Seoul (KR); Joonseok LEE, Seoul (KR); Wonjun CHOI, Seoul (KR); Jaewoo SEO, Seoul (KR)

(21) Appl. No.: 18/942,788

(22) Filed: Nov. 11, 2024

(30) Foreign Application Priority Data
May 30, 2022 (KR) 10-2022-0066205

(51) Int. Cl. G01N 27/12; G01N 27/30; G01N 27/333

(52) U.S. Cl. CPC G01N 27/127; G01N 27/126; G01N 27/308; G01N 27/333

(57) ABSTRACT

Disclosed are a cation sensor member, a cation sensor, and a manufacturing method therefor, the cation sensor member being based on a composite material of carbon nanotubes and a polymer having a functionalized receptor. A cation sensor member according to one embodiment may comprise: a polymer-carbon nanotube composite material prepared by mixing a pyridyl group-containing polymer and conductive carbon nanotubes; and a metal-porphyrin compound-based receptor functionalized to the polymer-carbon nanotube composite material, the receptor being prepared by chelating metal ions to porphyrins functionalized with the pyridyl groups.

### TECHNICAL FIELD

The present disclosure relates to a cation sensor member based on a composite material of carbon nanotubes and a polymer having a functionalized receptor, a cation sensor, and a manufacturing method therefor.

### BACKGROUND ART

Potentiometers and electrochemical sensor devices have been receiving much interest over the past few years. More recently, a great deal of attention has been focused on miniaturization and patterning of such sensor devices which range from bulk type to microchip-sized ones.

### DISCLOSURE OF INVENTION

### Technical Problem

The present disclosure provides a cation sensor member, which is capable of sensing cations contained in a solution in-situ in real time by combining carbon nanotubes and a polymer and functionalizing a receptor in the polymer that can interact with a positively charged ion component, a cation sensor, and a manufacturing method therefor.

### Solution to Problem

One embodiment of the present disclosure provides a cation sensor composite material comprising: a polymer-carbon nanotube composite material prepared by mixing a pyridyl group-containing polymer and conductive carbon nanotubes; and a metal-porphyrin compound-based receptor functionalized to the polymer-carbon nanotube composite material, the receptor being prepared by chelating metal ions to porphyrins functionalized with the pyridyl groups.

According to one aspect, the molecular weight (Mw) of the polymer may be in the range of 10,000 to 5,000,000 g/mol.

According to another aspect, the receptor may be composed of a heterocyclic compound consisting of four pyrrole groups, and contains multiple pyridyl groups.

According to still another aspect, metal components in the metal-porphyrin compound may include at least one of Be, Mg, Ca, Sr, Ba, Ra, Fe, Cd, Cr, Co, Cu, Pb, Mn, Hg, Ni, Pt, Sn, and Zn.

Another embodiment of the present disclosure provides a cation sensor comprising: the cation sensor composite material; a sensor substrate with the cation sensor composite material bonded to the top; and a sensor electrode disposed on the top of the sensor substrate so as to detect an electrical resistance change signal by a chemical interaction between the cation sensor composite material and the cations contained in a solution.

According to one aspect, a coating of the cation sensor composite material may be applied onto the top of the sensor substrate, with a line width range of 10 nm to 10 mm.

According to another aspect, the chemical interaction may occur with the cation sensor composite material when the solution is in the acidity (pH) range of 3 to 7.

According to still another aspect, the cations may include at least one of Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, and Zn²⁺.

According to a further aspect, the sensor substrate may include at least one of glass, polyethylene terephthalate (PET), polyethylene naphthalate (PEN), polycarbonates (PC), polyethersulfone (PES), polyimide (PI), cyclic olefin copolymer (COC), poly-di-methyl-siloxane (PDMS), silicon, and silicon oxide.

According to a further aspect, the senor platform device may further include: a rechargeable battery that supplies power to the charger and the sensor module; and a charging terminal for supplying external power to the rechargeable battery.

Still another embodiment of the present disclosure provides a manufacturing method for a cation sensor, comprising the steps of: (a) preparing a dispersion solution for a polymer-carbon nanotube composite material by mixing a pyridyl group-containing polymer and carbon nanotubes; (b) preparing the polymer-carbon nanotube composite material by evenly applying the dispersion solution onto a sensor substrate with a sensor electrode formed thereon; (c) preparing a metal-porphyrin compound-based receptor in which metal and porphyrins are bonded together by chelating metal ions to a porphyrin-based receptor containing pyridyl groups; and (d) functionalizing the receptor with the polymer-carbon nanotube composite material.

### Advantageous Effects of Invention

It is possible to sense cations contained in a solution in situ in real time by combining carbon nanotubes and a polymer and functionalizing a receptor in the polymer that can interact with a positively charged ion component.

### BRIEF DESCRIPTION OF DRAWINGS

The accompanying drawings, included as part of the detailed description in order to help understanding of the present disclosure, provide embodiments of the present disclosure and describe the technical characteristics of the present disclosure along with the detailed description.

FIG. 1 is a pattern diagram of a real-time cation sensor member and a cation sensor, that use a composite of carbon nanotubes and a polymer having a functionalized receptor, which illustrates Embodiment 1 and Test Example 1 of the present disclosure.

FIG. 2 is a flowchart of the steps of receptor compound preparation and cation sensor development, in Embodiment 1 and Test Example 1 of the present disclosure.

FIG. 3 is a photograph of a dispersion solution with carbon nanotubes and poly(4-vinylpyridine) dispersed in dimethylformamide, prepared according to Embodiment 1 of the present disclosure.

FIG. 4 is a photograph of a sensor substrate that is coated with a polymer-carbon nanotube composite prepared according to Embodiment 1 of the present disclosure.

FIG. 5 is a scanning electron microscopy (SEM) photograph of a polymer-carbon nanotube composite prepared according to Embodiment 1 of the present disclosure.

FIG. 6 shows a chemical structural formula of a receptor compound prepared according to Embodiment 1 of the present disclosure.

FIG. 7 is a Fourier-transform infrared spectroscopy (FT-IR) graph of a receptor compound prepared according to Embodiment 1 of the present disclosure.

FIG. 8 is a proton nuclear magnetic resonance (¹H NMR) graph of a receptor compound prepared according to Embodiment 1 of the present disclosure.

FIG. 9 is a photograph of a solution with a receptor compound prepared according to Embodiment 1 of the present disclosure dissolved in chloroform (CHCl₃).

FIG. 10 is a photograph of a sensor substrate that is coated with a composite material of carbon nanotubes and a polymer having a functionalized receptor, prepared according to Embodiment 1 of the present disclosure.

FIG. 11 is a Fourier-transform infrared spectroscopy (FT-IR) graph of a composite material of carbon nanotubes and a polymer having a functionalized receptor, prepared according to Embodiment 1 of the present disclosure.

FIG. 12 is a graph of an evaluation of the property of being sensitive to mercury cations, of a composite material of carbon nanotubes and a polymer having a functionalized receptor according to Test Example 1 of the present disclosure.

FIG. 13 is a graph showing a comparative evaluation of the property of being sensitive to mercury cations at different levels of acidity (pH), of a composite material of carbon nanotubes and a polymer having a functionalized receptor according to Test Example 1 of the present disclosure.

FIG. 14 is a graph showing a comparative evaluation of the property of being sensitive to mercury ions at different levels of acidity (pH), of a polymer-carbon nanotube composite material prepared according to Comparative Example 1 of the present disclosure.

FIG. 15 is a graph showing a comparative evaluation of the property of being sensitive to mercury cations with a concentration of 6.25 mM, of a composite material of carbon nanotubes and a polymer having a functionalized receptor prepared according to Comparative Example 1 of the present disclosure and a composite material of carbon nanotubes and a polymer having an unfunctionalized receptor prepared according to Test Example 1 of the present disclosure.

FIG. 16 is a graph showing a comparative evaluation of the property of being sensitive to various types of cations, of a composite material of carbon nanotubes and a polymer having a functionalized receptor according to Test Example 1 of the present disclosure.

### BEST MODE FOR CARRYING OUT THE INVENTION

It should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the embodiments described herein and the elements shown in the drawings is just a most preferred embodiment of the present disclosure, but not intended to fully describe the technical aspects of the present disclosure, so it should be understood that other equivalents and modifications could have been made thereto at the time the application was filed.

The present disclosure relates to a cation sensor member, which is capable of sensing cations contained in a solution in-situ in real time by combining carbon nanotubes and a polymer and functionalizing a receptor in the polymer that can interact with a positively charged ion component, a cation sensor, and a manufacturing method therefor. The polymer having a functionalized receptor may contain multiple pyridyl groups, and a chemical interaction may occur between the pyridyl groups and the cations contained in the solution. Specifically, the receptor may have a porphyrin structure and additionally include a pyridyl group as a functional group. Multiple metal ions may be chelated to a receptor with a porphyrin structure to form a metal-porphyrin receptor. The chelated metal-porphyrin receptor may be functionalized with a polymer having pyridyl groups containing an unshared electron pair to form a polymer having a functionalized receptor. As a result, the polymer having a functionalized receptor may contain highly densed pyridyl groups. The multiple pyridyl groups may exhibit high selectivity to heavy metal ions through a characteristic chemical interaction with the heavy metal ions. Once the receptor in the polymer combined with the carbon nanotubes is functionalized, the electrical resistance of the carbon nanotubes may be changed through a chemical interaction when cations such as heavy metals are injected into the polymer, and the degree of resistance change varies in real time depending on the concentration of cations. Thus, a composite material of carbon nanotubes and a polymer having a functionalized receptor may be used as a cation sensor member for monitoring contamination of water quality.

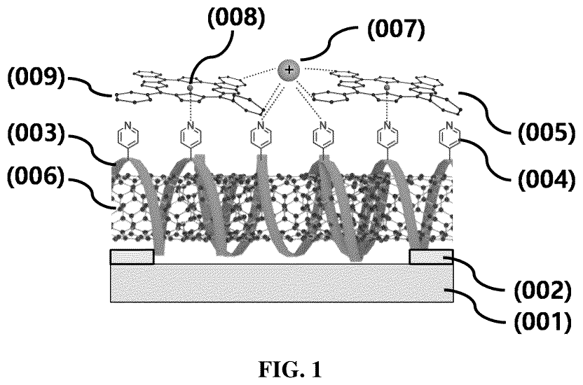

FIG. 1 is a pattern diagram of a real-time cation sensor member and a cation sensor, that use a composite of carbon nanotubes and a polymer having a functionalized receptor, which illustrates Embodiment 1 and Test Example 1 of the present disclosure. FIG. 1 depicts a composite material of carbon nanotubes 006 and a polymer 003 having a functionalized receptor 005. The composite material may be formed on a sensor substrate 001 where an electrode 002 is formed. Also, a metal-porphyrin receptor 005 with metal 008 bound to it may be formed by chelating metal ions to a porphyrin receptor. FIG. 1 depicts a functional group 009 of the receptor and the metal 008 at the center thereof. Such a metal-porphyrin receptor 005 may be functionalized with a polymer 003 having pyridyl groups 004 containing an unshared electron pair.

Such a composite material may translate a chemical interaction with an ion component 007 in a solution into an electrical signal, and may sense cations by detecting the electrical signal through the electrode 002 formed on the sensor substrate 001.

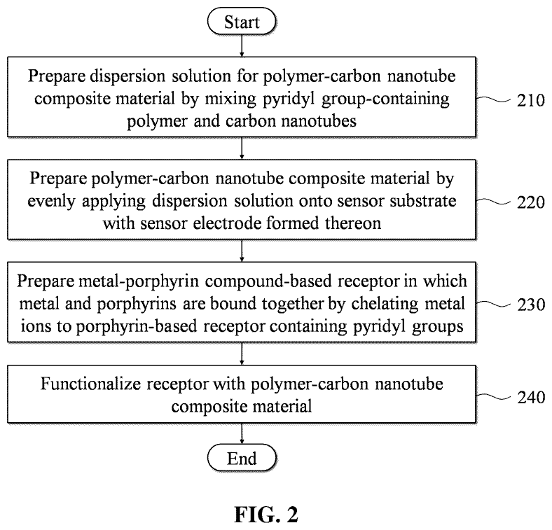

FIG. 2 is a flowchart of the steps of receptor compound preparation and cation sensor development, in Embodiment 1 and Test Example 1 of the present disclosure. A manufacturing method for a cation sensor according to the embodiment of FIG. 2 may include the step 210 of preparing a dispersion solution for a polymer-carbon nanotube composite material by mixing a pyridyl group-containing polymer and carbon nanotubes, the step 220 of preparing the polymer-carbon nanotube composite material by evenly applying the dispersion solution onto a sensor substrate with a sensor electrode formed thereon, the step 230 of preparing a metal-porphyrin compound-based receptor in which metal and porphyrins are bonded together by chelating metal ions to a porphyrin-based receptor containing pyridyl groups, and the step 240 of functionalizing the receptor with the polymer-carbon nanotube composite material.

In the step 210, the polymer content in the dispersion solution prepared by mixing a polymer and carbon nanotubes may be in the range of 0.01 to 500 relative to the weight of the carbon nanotubes. A solvent for dispersing the polymer-carbon nanotube composite material may include at least one solvent selected from ethanol, methanol, propanol, butanol, isopropyl alcohol (IPA), dimethylformamide (DMF), acetone, acetonitrile, toluene, tetrahydrofuran, 1,2-dichlorobenzene, water, and combinations thereof.

In the step 220, the sensor electrode may be formed on the sensor substrate through any one of metal paste coating, physical vapor deposition, and chemical vapor deposition. Also, in this case, the sensor substrate may be coated with the dispersion solution by using at least one of drop coating, spray coating, and dip coating.

In the step 230, the metal-porphyrin compound may be formed by chelating metal ions of at least one of Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, and Zn²⁺. For example, the receptor may be functionalized with the surface of the pyridyl group-containing polymer through a chemical interaction between the metal in the metal-porphyrin compound-based receptor and the pyridyl groups containing an unshared electron pair.

In the step 240, the receptor may be functionalized with the surface of the pyridyl group-containing polymer through a chemical interaction between the metal in the receptor and the pyridyl groups containing an unshared electron pair. In this case, the receptor may be functionalized with the polymer-carbon nanotube composite material by using at least one of drop coating, spray coating, and dip coating.

The composite material of carbon nanotubes and a polymer having a functionalized receptor may be a sensor sensing material capable of real-time sensing of various types of cations contained in the solution. For example, the composite material of carbon nanotubes and a polymer having a functionalized receptor may translate a chemical interaction with the cations contained in the solution into an electrical signal. In this case, the cations may be sensed by detecting the electrical signal through the sensor electrode formed on the sensor substrate. For example, the composite material of carbon nanotubes and a polymer having a functionalized receptor may transmit a resistance change signal through an electrode patterned on the sensor substrate. In this instance, the sensor substrate with the composite material bonded to it may be physically connected to a sensor module and measure an electrical signal change of the composite material through the sensor module. In this way, it is possible to manufacture a cation sensor capable of portable real-time water quality management by using conductive carbon nanotubes and a polymer having a functionalized receptor that can chemically interact with a cationic component. Moreover, a composite material of carbon nanotubes and a polymer having a functionalized receptor and containing multiple pyridyl groups may be used as a cation sensor sensing material that translates a chemical interaction with multiple harmful heavy metal ions contained in the solution into an electrical signal. In addition, the manufactured cation sensor may detect harmful heavy metal cations in real time based on how resistance changes with the concentration of cations.

Such a sensing material may include multiple pyridyl groups, and may sense cations through a chemical interaction between the pyridyl groups and positively charged ions contained in the solution.

The sensing material may form a composite material by mixing a pyridyl group-containing polymer and carbon nanotubes with high electrical conductivity. Additionally, the receptor may be functionalized in order to improve the sensitivity and selective sensing property of a polymer-carbon nanotube composite material to cations, and in order to sensitively sense cations in a solution having a wide range of acidity (pH). The receptor may contain multiple pyridyl groups and increase the concentration of pyridyl groups functionalized with the surface of the polymer-carbon nanotube composite material. The receptor may include a porphyrin structure and include pyridyl groups as ligands. Porphyrins may be chelated to multiple cations to form a receptor compound bound to metal. The receptor compound bound to metal may be functionalized with a pyridyl group-containing polymer having an unshared electron pair. When positively charged ions are injected into it, a composite material of carbon nanotubes and a polymer having a functionalized receptor may change electrical characteristics of the carbon nanotubes through a chemical interaction with the pyridyl groups. Thus, the composite material of carbon nanotubes and a polymer having a functionalized receptor may exhibit outstanding cation sensing property compared to a composite material of carbon nanotubes and a polymer having an unfunctionalized receptor, and may exhibit the property of sensing cations over a wide range of pH values, as well as the property of selectively sensing cations. Various types of receptors may build a library of functionalized polymer-carbon nanotube materials depending on the type of the metal chelated to the receptor, and may sense a plurality of cationic components.

Moreover, a composite material of carbon nanotubes and a polymer having a functionalized receptor may be evenly applied or patterned onto the top of a sensor substrate where an electrode for evaluating electrical characteristics is patterned. When cations are injected, the electrical conductivity of the carbon nanotubes may be changed through a chemical interaction between the cations and the pyridyl groups. Thus, the electrical conductivity of the composite material may be sensed in real time through the electrode to use it as a resistance-varying cation sensor. Since the degree of chemical interaction with the pyridyl groups changes with the concentration of cations, it is possible to manufacture a cation sensor in which the degree of resistance change varies with concentration. Since a sensor substrate including a sensor electrode and a composite material of carbon nanotubes and a polymer having a functionalized receptor can be miniaturized, a portable, real-time cation sensor can be provided.

In some embodiments, the carbon nanotubes may include metallic carbon nanotubes and/or carbon nanotubes exhibiting semiconducting properties. Also, the carbon nanotubes may include a single-walled or multi-walled structure.

In addition, the receptor may include a heterocyclic compound-based macrocyclic structure (heterocyclic macrocycle organic compounds) composed of a porphyrin structure. In this case, in the porphyrin-based receptor, multiple ligands may be functionalized, and the ligands may contain pyridyl groups. Meanwhile, the porphyrins may consist of four pyrrole groups.

The porphyrins may combine with various metal components (Be, Mg, Ca, Sr, Ba, Ra, Fe, Cd, Cr, Co, Cu, Pb, Mn, Hg, Ni, Pt, Sn, and Zn) to form a metal-porphyrin compound. Also, the porphyrins may chemically interact with various metal ions (Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, and Zn²⁺) to form a metal-porphyrin-based receptor. In this case, the porphyrin-based receptor combined with the metal may be chemically functionalized with a pyridyl group-containing polymer.

As previously explained, the composite material of carbon nanotubes and a polymer having a functionalized receptor may include those with which the top of a sensor substrate with an electrode (sensor electrode) coating for evaluating electrical properties is coated. In this case, the line width of the composite material of carbon nanotubes and a polymer having a functionalized receptor, with which the sensor substrate is coated, may be in the range of 10 nm to 10 mm. Meanwhile, the sensor substrate may include at least one of glass, polyethylene terephthalate (PET), polyethylene naphthalate (PEN), polycarbonates (PC), polyethersulfone (PES), polyimide (PI), cyclic olefin copolymer (COC), poly-di-methyl-siloxane (PDMS), silicon, and silicon oxide. The composite material of carbon nanotubes and a polymer having a functionalized receptor may translate a chemical interaction between the multiple pyridyl groups and the cationic component contained in the solution into an electrical signal. In this case, the composite material of carbon nanotubes and a polymer having a functionalized receptor may show a chemical interaction when the solution is in the acidity (pH) range of 3 to 7, and exhibit a change in the resistance of the carbon nanotubes as a cation-containing solution is injected. Cations that induce a chemical interaction with the composite material of carbon nanotubes and a polymer having a functionalized receptor may include at least one of Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, and Zn²⁺. Meanwhile, the resistance of the composite material of carbon nanotubes and a polymer having a functionalized receptor may change in the range of 1 kΩ to 100 MΩ.

### Embodiment 1: Step of Preparing Composite Material of Carbon Nanotubes and Polymer Having Functionalized Receptor Containing Multiple Pyridyl Groups

To prepare a composite material of carbon nanotubes and a polymer having a functionalized receptor, a polymer-carbon nanotube composite material which has a polymer physically bound to the surfaces of the carbon nanotubes is prepared. The polymer used in this embodiment is poly(4-vinylpyridine) (P4VP) containing multiple pyridyl groups and having a molecular weight of 200,000 g/mol, more suitably, a molecular weight range of 10,000 to 5,000,000 g/mol. The polymer-carbon nanotube composite material may be prepared by coating a polymer-carbon nanotube dispersion solution onto a glass substrate by spray coating. The polymer-carbon nanotube dispersion solution is prepared by completely dissolving 30 mg of P4VP in 6 mL of dimethylformamide (DMF), adding 3 mg of carbon nanotubes, and then dispersing the mixture for 1 hour by using an ultrasonic atomizer. The glass substrate is coated with the prepared dispersion solution by spray coating with an airbrush under a pressure of 1 bar. The polymer-carbon nanotubes with which the glass substrate is coated are heated to 130° C., thereby preparing a mechanically stable, polymer-carbon nanotube composite material with a chemical covalent bond on the glass substrate. Additionally, the prepared polymer-carbon nanotube composite material is washed with dichloromethane (DCM) to remove a polymer-carbon nanotube composite that is not bonded to the substrate.

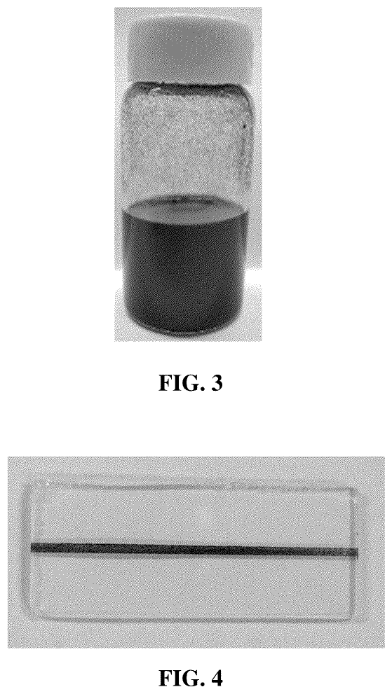

FIG. 3 shows a dispersion solution with a composite material of carbon nanotubes and poly(4-vinylpyridine) uniformly dispersed in dimethylformamide (DMF). The dispersion solution is prepared by completely dissolving 30 mg of P4VP in 6 mL of dimethylformamide (DMF), adding 3 mg of carbon nanotubes, and then dispersing the mixture for 1 hour using an ultrasonic atomizer.

FIG. 4 is a photograph of a polymer-carbon nanotube composite with which a glass substrate is coated. The composite coating may be applied in a linear fashion.

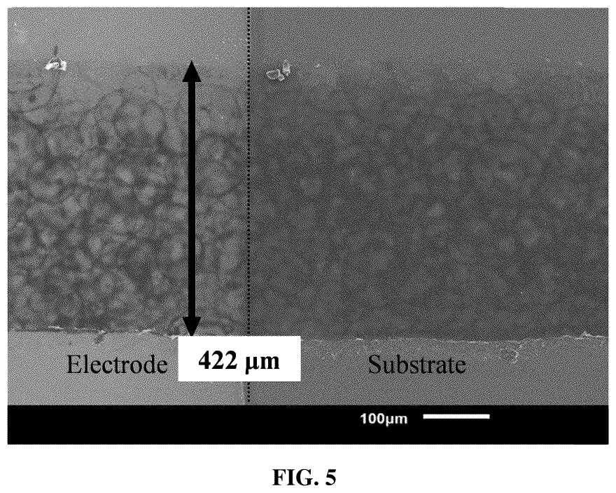

FIG. 5 is a scanning electron microscopy (SEM) photograph of a polymer-carbon nanotube composite coating applied on a substrate across a line width of 422 μm. It can be observed that the electrode and the top of the substrate are coated with the polymer-carbon nanotube composite.

To improve the cation sensing property of a composite material of carbon nanotubes and a pyridyl group-containing polymer, a receptor compound capable of chemical interaction with cations was prepared and functionalized. The receptor compound is prepared by chelating various metals to the center of 5,10,15,20-Tetra(4-pyridyl)-21H,23H-porphine (TPyP) with meso-substituted pyridyl functional groups.

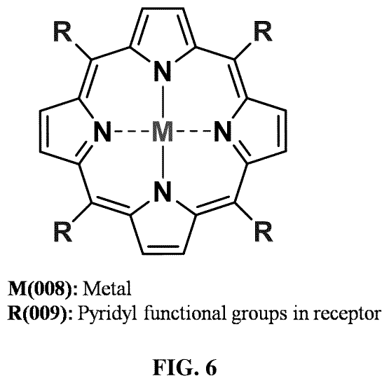

FIG. 6 shows a chemical structural formula of a receptor compound having a porphyrin structure. In the receptor compound, metal ions are bound to the center of a porphyrine molecule by chelation, with meso-substituted pyridyl groups.

In this embodiment, a receptor (Zinc 5,10,15,20-Tetra(4-pyridyl)-21H, 23H-porphine; ZnTPyP) capable of reacting with cations was prepared by chelating Zinc (Zn). Specifically, 6 mL of a methanol solution with 420 mg of zinc acetate dehydrate dissolved in it is added to 24 mL of a chloroform (CHCl₃) solution with 124 mg of porphyrin dissolved in it. The reaction solution is refluxed for 10 hours at 65° C. After the reaction, the solvent is evaporated from the solution by using a vacuum evaporation concentrator, and the solution is re-dispersed in methanol and filtered, thereby obtaining a reaction product. The reaction product is purified using methanol and dichloromethane to obtain a receptor compound. The prepared receptor compound undergoes a structural analysis through Fourier-transform infrared spectroscopy (FT-IR) and proton nuclear magnetic resonance (¹H NMR).

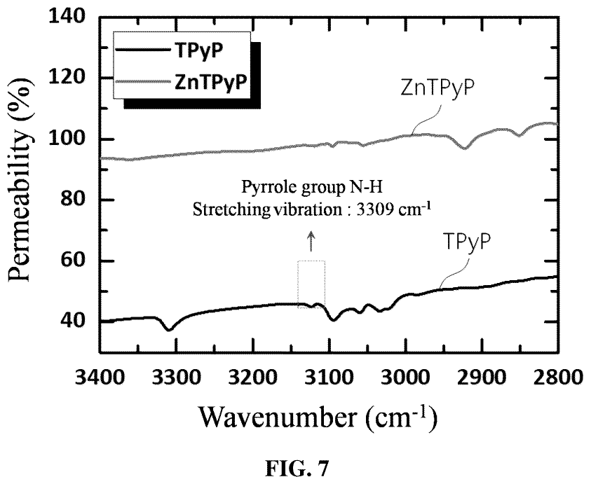

FIG. 7 is a Fourier-transform infrared spectroscopy (FT-IR) graph for identifying that metal ions are chelated to the center of a porphyrin molecule, in synthesis of a receptor compound. For an unchelated porphyrin molecule, the wavenumber of the vibration of N—H in a pyrrole group is 3,309 cm⁻¹, whereas, for a chelated receptor compound, the vibration of N—H in the pyrrole group is eliminated as the hydrogen atoms at the center of the porphyrin molecule are dequantized by a chelation reaction.

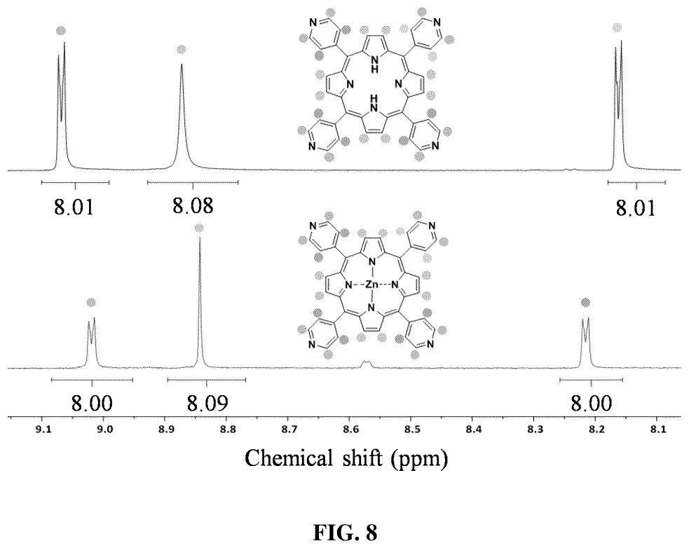

FIG. 8 is a proton nuclear magnetic resonance (¹H NMR) graph for identifying synthesis of a receptor compound. From the proton nuclear magnetic resonance graph, the numbers of protons in a porphyrin molecule and a receptor compound can be identified, and it is observed that the receptor compound has 24 hydrogen atoms, and that a change is made to the chemical shift of hydrogen atoms as a chelation takes place at the center of the porphyrin molecule.

A receptor compound solution is prepared in order to functionalize the receptor compound with a polymer-carbon nanotube composite material. The receptor compound solution was prepared by oversaturating the receptor compound in chloroform (CHCl₃) and then filtering it through a syringe filter.

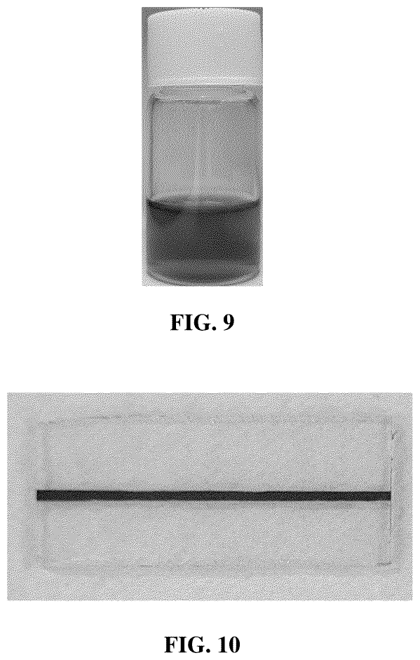

FIG. 9 is a photograph of a receptor compound solution prepared to functionalize a receptor compound with a polymer-carbon nanotube composite. The receptor compound solution was prepared by oversaturating the receptor compound in chloroform (CHCl₃) and then filtering it through a syringe filter, thereby obtaining a purple transparent solution.

FIG. 10 is a photograph of a composite material of carbon nanotubes and a polymer having a functionalized receptor compound. The receptor compound may be functionalized by a chemical bond between the pyridyl groups in the polymer and the metal ions at the center of the receptor compound, by applying a coating of the receptor compound solution.

The functionalization is achieved by coating the polymer-carbon nanotube composite with the receptor compound solution. The receptor compound can be functionalized by a chemical bond between the pyridyl groups in the polymer and the metal ions at the center of the receptor compound. The composite of carbon nanotubes and a polymer having a functionalized receptor is analyzed through Fourier-transform infrared spectroscopy (FT-IR).

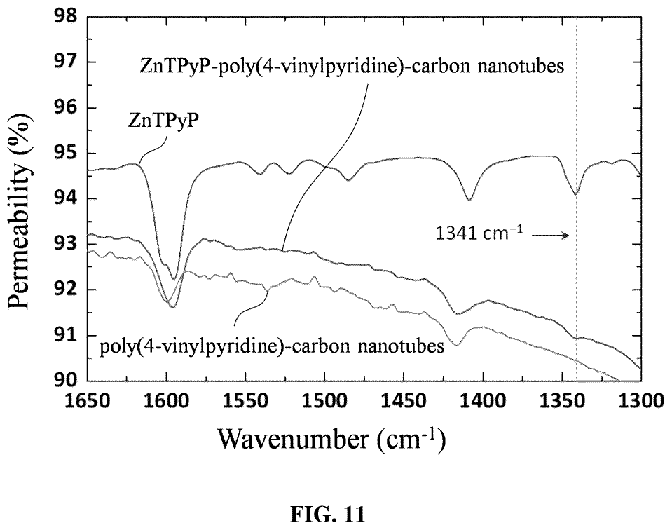

FIG. 11 is a Fourier-transform infrared spectroscopy (FT-IR) graph for identifying functionalization of a receptor compound. A composite of carbon nanotubes, a polymer and a receptor having a functionalized receptor compound shows a characteristic vibration at 1,341 cm⁻¹ by functionalizing the receptor.

### Comparative Example 1: Step of Preparing Composite Material of Carbon Nanotubes and Polymer Having Unfunctionalized Receptor

In Comparative Example 1, a detailed description will be given of a test in which the cation sensing property of a composite of a polymer and carbon nanotubes that has not undergone a receptor compound functionalization process are evaluated in order to evaluate a chemical interaction between the receptor compound and the cations.

As set forth in Embodiment 1, a polymer-carbon nanotube composite material may be prepared under the same conditions. It should be noted that a composite material of carbon nanotube and a polymer having an unfunctionalized receptor may be prepared by omitting the step of preparing a porphyrin-based receptor compound and the step of functionalizing the receptor.

A chemical interaction with the cations contained in the solution may be comparatively evaluated by using the prepared composite material of carbon nanotubes and a polymer having an unfunctionalized receptor.

### Test Example 1: Step of Evaluating Property of Sensing Environmentally Harmful Heavy Metal Cations by Using Cation Sensor Sensing Materials Prepared According to Embodiment 1 and Comparative Example 1

In Test Example 1, a description will be made with respect to a method of comparatively evaluating the sensing property of a cation sensor by translating a chemical interaction between a receptor and cations by using a composite material of carbon nanotubes and a polymer having a functionalized receptor, prepared according to Embodiment 1, and a composite material of carbon nanotubes and a polymer having an unfunctionalized receptor, prepared according to Comparative Example 1.

The evaluation of the sensitivity of the cation sensor may be done in aqueous solutions with an acidity (pH) of 4.5 and 5.7. A quantitative sensitivity evaluation may be done by measuring a change in resistance that occurs when a cation-containing solution is injected into a sensing material after an aqueous solution containing no cations is injected into the sensing material. The change in resistance may be calculated by (R₀−R)/R₀×100%. Here, R₀ is the resistance measured when the solution containing no cations is injected, and R is the resistance measured when the cation-containing solution is injected. In this test example, the change in resistance was measured by using a Keithley 2400 source meter.

The concentration of cations may be measured in the range of 0.63 mM to 6.3 mM. When the cation-containing solution is injected in a variety of concentration ranges, a chemical interaction between the cations and the composite sensing material of carbon nanotubes and a polymer having a functionalized receptor is translated into an electrical signal of varying strength depending on the concentration range of cations, and the sensing property may be evaluated by measuring changes in electrical resistance in real time.

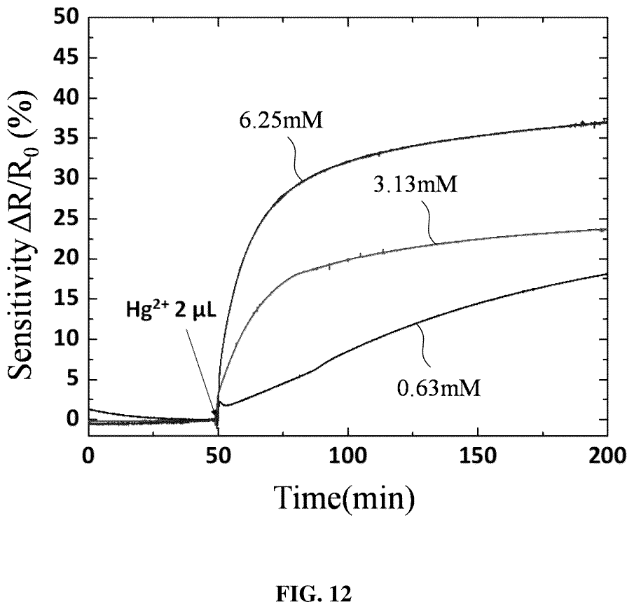

FIG. 12 is a graph of an evaluation of the property of being sensitive to mercury (Hg²⁺) cations in an aqueous solution with a pH of 5.7, of a receptor-polymer-carbon nanotube composite. A 30 μL aqueous solution with a pH of 5.7 that does not contain mercury cations was injected into the sensor and a stabilization step was performed. Upon completion of the stabilization step, a 2 μL aqueous solution containing mercury ions was additionally injected, and resistance changes were observed. It was observed that the sensitivity of the sensor increased with increasing concentration of mercury cations, and that the sensor exhibited a sensitivity of 37% for 6.25 mM mercury ions.

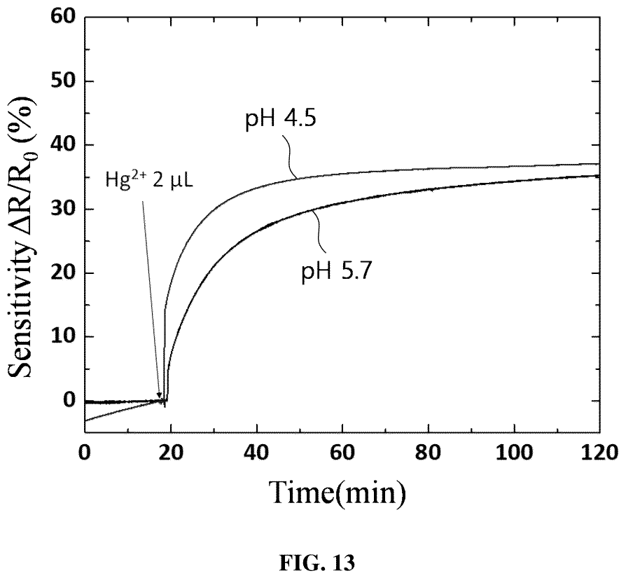

FIG. 13 is a graph showing the property of being sensitive to mercury cations with a concentration of 6.25 mM at different levels of acidity, pH 4.5 and pH 5.7, of a composite material of carbon nanotubes and a polymer having a functionalized receptor. 30 μL aqueous solutions with different acidity levels (pH) were injected into the cation sensor and a stabilization step was performed. Upon completion of the stabilization step, a 2 μL aqueous solution containing mercury ions was additionally injected into the sensor. At this point, the sensitivity was similar regardless of acidity.

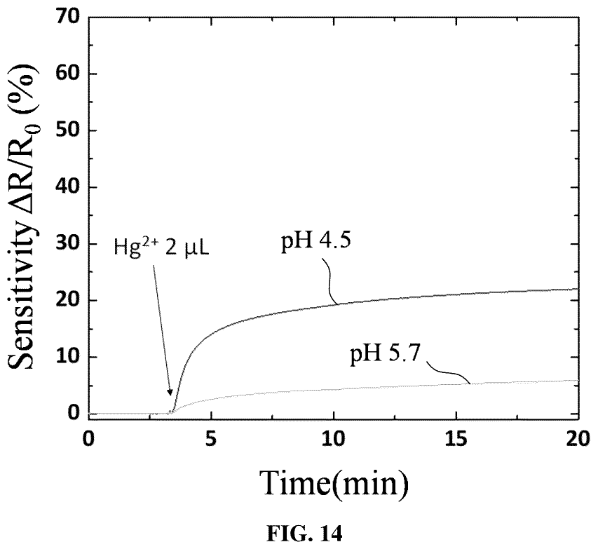

FIG. 14 is a graph showing the property of being sensitive to mercury cations with a concentration of 6.25 mM at different levels of acidity (pH), 4.5 and 5.7, of a composite material of carbon nanotubes and a polymer having a unfunctionalized receptor. The composite material of carbon nanotubes and a polymer having an unfunctionalized receptor exhibited a low sensitivity of 5.2% at a pH of 5.7, and the sensitivity increased from 5.2% to 22.2% with decreasing acidity (pH).

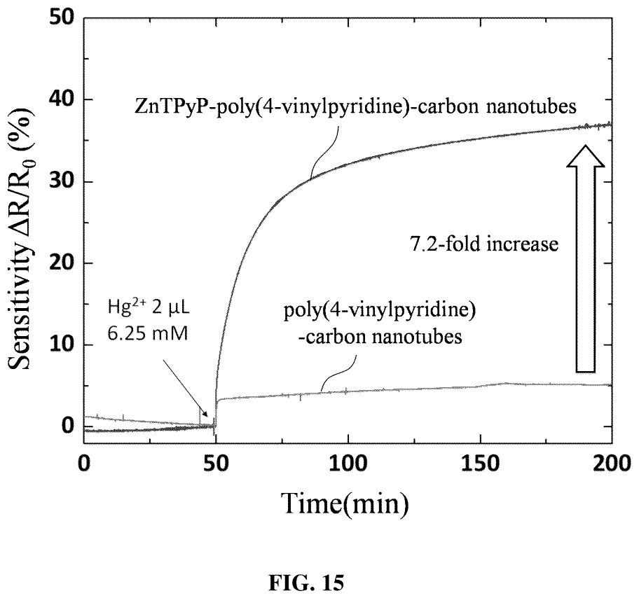

FIG. 15 is a graph showing a comparative evaluation of the property of being sensitive to mercury cations with a concentration of 6.25 mM at an acidity (pH) of 5.7, of a composite material of carbon nanotubes and a polymer having a functionalized receptor and a composite material of carbon nanotubes and a polymer having an unfunctionalized receptor. It was observed that the composite sensing material of carbon nanotubes and a polymer having a functionalized receptor exhibited a 7.2-fold increase in sensitivity.

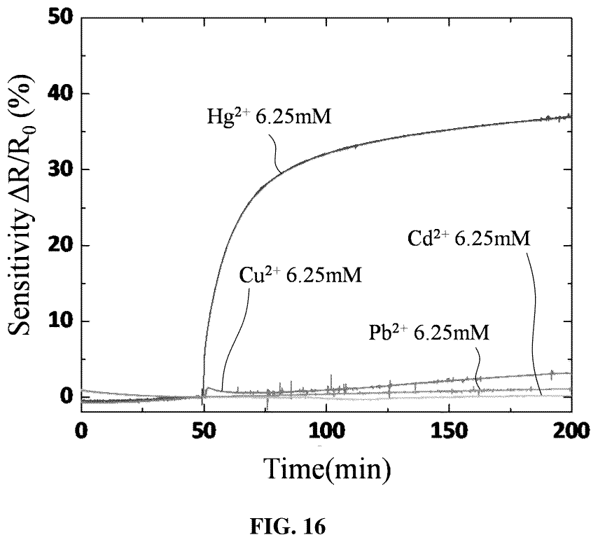

FIG. 16 is a graph showing a comparison of the property of being sensitive to various types of cations at an acidity (pH) of 5.7, of a composite material of carbon nanotubes and a polymer having a functionalized receptor. It was observed that the composite material of carbon nanotubes and a polymer having a functionalized receptor exhibited high sensitivity to mercury cations and low reactivity to other types of cations. From this, it was found out that the composite material has outstanding selective sensing property to mercury ions.

As such, according to the embodiments of the present disclosure, it is possible to sense cations contained in a solution in situ in real time by combining carbon nanotubes and a polymer and functionalizing a receptor in the polymer that can interact with a positively charged ion component.

For example, it is possible to sense harmful heavy metal cations contained in a solution in real time by using a composite material of carbon nanotubes and a polymer having a functionalized receptor containing multiple pyridyl groups. The pyridyl groups contain an unshared electron pair, and may be used as a cation sensor by forming a chemical bond with positively charged ions. The receptor contains multiple pyridyl groups, and, if the receptor is functionalized with the polymer-carbon nanotube surfaces, the concentration of pyridyl groups capable of chemically interacting with heavy metal cations may increase, thereby achieving better heavy metal cation sensing property compared to a composite material of carbon nanotubes and a polymer having an unfunctionalized receptor. Moreover, the cation sensor using the composite material of carbon nanotubes and a polymer having a functionalized receptor has the effect of sensing heavy metal ions with higher sensitivity in a solution with a wider range of acidity (pH) than the composite material of carbon nanotubes and a polymer having an unfunctionalized receptor. Since the electrical conductivity of the carbon nanotubes changes due to the chemical interaction, heavy metal ions can be sensed in real time by monitoring resistance changes.

### MODE FOR CARRYING OUT THE INVENTION

Although the embodiments have been described above with reference to the limited embodiments and drawings, those skilled in the art may apply various technical modifications and variations on the basis of the above description. For example, appropriate results may be achieved even when the described technique is performed in a different order from the described method and/or the components of the described system, structure, device, circuit and the like may be combined in a different form or replaced or substituted by other components or equivalents.

Therefore, other implementations, other embodiments, and those equivalents to the claims are within the scope of the claims to be described below.

1. A cation sensor composite material comprising:
a polymer-carbon nanotube composite material prepared by mixing a pyridyl group-containing polymer and conductive carbon nanotubes; and
a metal-porphyrin compound-based receptor functionalized to the polymer-carbon nanotube composite material, the receptor being prepared by chelating metal ions to porphyrins functionalized with the pyridyl groups.

2. The cation sensor composite material of claim 1, wherein the molecular weight (Mw) of the polymer is in the range of 10,000 to 5,000,000 g/mol.

3. The cation sensor composite material of claim 1, wherein the receptor is composed of a heterocyclic compound consisting of four pyrrole groups, and contains multiple pyridyl groups.

4. The cation sensor composite material of claim 1, wherein metal components in the metal-porphyrin compound includes at least one of Be, Mg, Ca, Sr, Ba, Ra, Fe, Cd, Cr, Co, Cu, Pb, Mn, Hg, Ni, Pt, Sn, and Zn.

5. A cation sensor comprising:
the cation sensor composite material of claim 1;
a sensor substrate with the cation sensor composite material bonded to the top; and
a sensor electrode disposed on the top of the sensor substrate so as to detect an electrical resistance change signal by a chemical interaction between the cation sensor composite material and the cations contained in a solution.

6. The cation sensor of claim 5, wherein a coating of the cation sensor composite material is applied onto the top of the sensor substrate, with a line width range of 10 nm to 10 mm.

7. The cation sensor of claim 5, wherein the chemical interaction occurs with the cation sensor composite material when the solution is in the acidity (pH) range of 3 to 7.

8. The cation sensor of claim 5, wherein the cations include at least one of Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, and Zn²⁺.

9. The cation sensor of claim 5, wherein the sensor substrate includes at least one of glass, polyethylene terephthalate (PET), polyethylene naphthalate (PEN), polycarbonates (PC), polyethersulfone (PES), polyimide (PI), cyclic olefin copolymer (COC), poly-di-methyl-siloxane (PDMS), silicon, and silicon oxide.

10. A manufacturing method for a cation sensor, comprising the steps of:
(a) preparing a dispersion solution for a polymer-carbon nanotube composite material by mixing a pyridyl group-containing polymer and carbon nanotubes;
(b) preparing the polymer-carbon nanotube composite material by evenly applying the dispersion solution onto a sensor substrate with a sensor electrode formed thereon;
(c) preparing a metal-porphyrin compound-based receptor in which metal and porphyrins are bonded together by chelating metal ions to a porphyrin-based receptor containing pyridyl groups; and
(d) functionalizing the receptor with the polymer-carbon nanotube composite material.

11. The manufacturing method of claim 10, wherein the composite material of carbon nanotubes and a polymer having a functionalized receptor translates a chemical interaction with the cations contained in the solution into an electrical signal, and the cations are sensed by detecting the electrical signal through the sensor electrode formed on the sensor substrate.

12. The manufacturing method of claim 10, wherein, in the step (d), the receptor is functionalized with the surface of the pyridyl group-containing polymer through a chemical interaction between the metal in the receptor and the pyridyl groups containing an unshared electron pair.

13. The manufacturing method of claim 10, wherein, in the step (c), the metal-porphyrin compound is formed by chelating metal ions of at least one of Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, and Zn²⁺.

14. The manufacturing method of claim 10, wherein, in the step (a), the polymer content in the dispersion solution is in the range of 0.01 to 500 relative to the weight of the carbon nanotubes.

15. The manufacturing method of claim 10, wherein the sensor electrode is formed on the sensor substrate through any one of metal paste coating, physical vapor deposition, and chemical vapor deposition, the sensor substrate is coated with the dispersion solution by using at least one of drop coating, spray coating, and dip coating, and the receptor is functionalized with the polymer-carbon nanotube composite material by using at least one of drop coating, spray coating, and dip coating.
